(19) United States
(12) Patent Application Publication
(10) Pub. No.: US 2026/0070701 A1
(43) Pub. Date: Mar. 12, 2026

(54) PRODUCTS, EQUIPMENT, AND METHODS FOR FIELD FABRICATION, USE, AND INSTALLATION OF SKINNED CELLULOSE ASSEMBLIES

(71) Applicant: CleanFiber Inc., Blasdell, NY (US)

(72) Inventors: Jonathan Strimling, Bedford, NH (US); Randell Drane, Winchester, MA (US); Michael Bilodeau, Clermont, FL (US)

(73) Assignee: CleanFiber Inc., Blasdell, NY (US)

(21) Appl. No.: 18/708,517

(22) PCT Filed: Nov. 9, 2022
(86) PCT No.: PCT/US2022/049465

§ 371 Date: May 8, 2024

Related U.S. Application Data
(60) Provisional application No. 63/277,599, filed on Nov. 9, 2021.

(51) Int. Cl. B65D 5/56; B31B 50/74; B32B 3/04; B32B 5/02; B32B 9/00; B32B 9/04

(52) U.S. Cl. CPC B65D 5/56; B31B 50/74; B32B 3/04; B32B 5/02; B32B 9/005; B32B 9/047; B32B 2262/062; B32B 2307/206; B32B 2307/56; B32B 2553/02

(57) ABSTRACT

A skinned cellulose assembly for packaging includes a cellulosic insulation material, a skin to contain the cellulosic insulation material, and a binder used to close the skin to retain at least a portion of the cellulosic insulation material. A method and machine are described for making the skinned cellulose assembly. A cellulose insulation assembly is also described for insulating a building structure. The insulation assembly includes the cellulose insulation material inside the skin, wherein the insulation assembly is sized to fit in a cavity so as to be inserted into and then to insulate the cavity. A method and machine for making the insulation assembly are also described.

### BACKGROUND OF THE INVENTION

### 1. Field of the Invention

The present invention relates to skinned assemblies containing cellulose fibers and methods of making the same. More particularly, the present invention relates to insulated assemblies made of low density cellulose-based materials coupled with barrier components and methods of their manufacture and installation, including production of assemblies at the location of installation. These skinned assemblies made from cellulose may have insulative and/or cushioning properties and be used in packaging, building insulation, and/or other applications.

### 2. Description of the Prior Art

The insulation of buildings typically occurs onsite (in the field), where the building exists. That often occurs in the physical location where the building stands or in production facilities where building prefabrication units exist. Insulation is primarily either blown into place in building cavities, such as spaces between studs, or as batts of insulation that have been fabricated elsewhere and transported to the building location.

Insulation is most often made of fiberglass that comes in prefabricated batts of particular size and shape that are delivered to the installation site. Fiberglass has desirable qualities of insulation value, low weight, and ease of fabrication. However, there are also undesirable qualities that are becoming increasingly prominent, including but not limited to the environmental impact of such material.

Inexpensive insulative packaging structures that are available and continue to be used to thermally insulate and/or limit content damage as packaging material primarily comprise Styrofoam pieces, plastic pillows, and paper. Each has its limitations and so alternatives to the same, including cellulose-based packaging, are under consideration. Cellulose fibers would make an excellent solution for void-fill applications; however, cellulose fibers can be dusty. Cellulose fiber fill may not be suitable for direct contact with package contents as it may contaminate certain contents of packages, such as food items or items with small holes that could trap fiber. Loose fill cellulose inside a package could also create a mess for the person opening a package.

Cellulose insulation products are becoming effective alternatives to fiberglass insulation products. They may be made of recyclable cellulosic components and are more environmentally friendly than fiberglass. The insulative characteristics of cellulose-based products are improving. A concern that limits widespread usage o cellulosic insulation relates to the cost of the product, particularly the cost of moving materials to the installation site and the process of installing cellulosic insulation. What is needed is a better way to get effective cellulose-based insulation installed where desired. The materials that are suitable for that purpose can also be used in packaging, avoiding issues with contamination and handling loose cellulose fiber in packaging applications.

### SUMMARY OF THE INVENTION

The present invention is embodied in one or more products, one or more methods, and one or more machines for carrying out the methods to make the products. The products are skinned cellulose assemblies. For purposes of describing the present invention, an assembly is a combination of two or more components of different types joined together to provide a desired function. For example, a batt comprising a skin or skins joined to or adjacent to an insulative material. For the present invention, the insulative material is a cellulosic material. The assembly may be formed at the site of installation by an installer, or it may be formed near the site of installation by a manufacturer or distributor. The installer may fabricate the insulation assembly, install the assembly in the field, or both.

The invention enables an insulation installer to begin with a skin material, such as paper in roll form, and cellulose insulation, which may be compressed cellulose material. The installer may feed the paper and cellulose together into a machine of the invention that forms batts of cellulose affixed to the paper in field. The batt may be removed from the machine and inserted into a location to be insulated, such as into a wall cavity to be insulated. The batts formed may be of selectable length and width to be programmed into the machine or otherwise adjusted manually. That process enables separate transport of the skin material and the insulation material to the installation site. Alternatively, the process of forming the batts could also be completed by an insulation distributor, who forms batts near the point of use by installers and then sells the formed batts for installation. This same process of making insulation on site can also be used to fabricate packaging products, where assemblies that provide thermal and/or cushioning insulation can be formed near the point-of-use of packaging. There may also be applications of folded and/or expansible paper-based products in forming insulated assemblies in the manner described above.

By forming the insulated assemblies closer to the point-of-use, there is no need to ship highly bulky insulating materials through layers of the supply chain. That is, skin material and insulation material may be shipped separate from one another and reconstituted and/or assembled at the installation site. Also, by forming the insulation assemblies at the point of use, batts can be formed to the exact dimensions required. Further, by forming skinned insulated assemblies closer to the point of use, loose-blown cellulosic insulation components of the assemblies can be optimally fluffed, with cellulose fibers optimally separated from one another to achieve the highest potential R-values with a minimum of materials that may otherwise occur with prior fabrication and shipment of the batt, which can result in settling that would otherwise reduce R-value.

The insulation assemblies may be made with one skin only joined to the insulation material or a first skin and a second skin encompassing the insulation material. The first skin and the second skin of the cellulose-based product used to retain the mat insulation material therebetween are barrier components of the product. The barrier components perform as airflow stops on both surfaces of the product that effectively converts an open-cell structure of the cellulose insulative material construct to a product having an effective closed-cell structure. The barrier components may be made of kraft paper, recycled paper, or other type of material suitable for the intended function of the product. For example, a flexible skin may be formed from polymeric materials, or a paper material that was previously laminated with polymeric materials. One or more skins may include extruded foam sheets. Alternatively, one or more skins may be of rigid materials such as ceramic-based materials that have insulative properties. The first skin and the second skin may or may not be water resistant. The cellulosic insulation may be retained to either or both of the first and second skin with a binder that binds the insulation material to the skin(s)s. Other attachment options are possible, such as by mechanical attachment but not limited thereto. The assembly including a skin that is formed by the combination of these components may be foldable, bendable, and/or cuttable as desired. The insulation assemblies may be of a particular dimensional scale, such as designed to fit into a bay between two studs in a building. Alternatively, the insulation assemblies may be of a much smaller dimensions, such as in the form of small tubes, balloons, or other small insulation assemblies, where numerous smaller assemblies may then be inserted to fill a cavity. As but one example, small tubes of 0.25-1 inch in diameter and of 0.5-2 inches in length may be formed and filled, and then blown to fill much larger cavities.

The small tubes may be joined together into a string of small tubes. For example, a long tube may be compressed in sections to form smaller tubes that are filled with cellulose with the compressed tube forming a bridge between the filled sections. The compressed section may be compressed through a crimping action, a twisting action, or other means to compress a section of a longer tube to avoid it being filled and to seal a filled section of tube on either side of the compressed section. A string of such small tubes would have the form of a string of sausages. This could have applications in void fill machines where an operator can pull out the number of small tubes required to fill a void and then cut or tear off the necessary number of small tubes.

The present invention is represented by a plurality of embodiments of skinned cellulose assemblies. Specifically, there is a packaging product, method, and forming machine. There is also an insulation product, method, and forming machine. The packaging product embodiment is a padded skinned assembly for application in packaging applications that includes a cellulosic insulation body, a skin to contain the cellulosic insulation body, and a binder to close the skin to retain at least a portion of the cellulosic insulation body inside the skin, wherein the skinned assembly is sized to fit a particular geometry cavity so as to be inserted into that cavity and to fit snugly and to provide insulation and/or padding therein. There is also an embodiment of the padded skinned assembly product with the skin, cellulosic insulation body, and binder, wherein multiple padded skinned assemblies are utilized inside a container for the purpose of providing cushioning or insulation to the contents of a package in the container. The skin may be formed into a tubular shape. The tubular shape may be formed into a plurality of tubular sections, wherein each tubular section includes the cellulosic insulation material, wherein adjacent ones of the tubular sections are connected to one another but isolated so that the cellulosic insulation material does not move from one tubular section to another, and wherein a first portion of the tubular sections may be separated from a second portion of the tubular sections.

The embodiment of the invention for a method of making the packaging product includes the steps of forming a skinned cellulose assembly with a cellulosic insulation material and a skin to contain the cellulosic insulation material and filling a void in a package with the skinned cellulose assembly, wherein the skinned cellulose assemblies are designed to fit snugly in the package. Another embodiment of the invention as a packaging method includes the steps of forming a plurality of skinned cellulose assemblies, wherein each of the skinned cellulose assemblies includes a cellulosic insulation material contained in a skin and filling a void in a package with the plurality skinned cellulose assemblies, wherein the number of skinned cellulose assemblies selected for insertion in the package is such as to predominantly fill the void in the package.

In an embodiment of the invention representing a machine for forming a cellulose packaging assembly, the machine assembles a skinned cellulose assembly with means to form one or more skins from a skin material of controlled dimensions, means to assemble the one or more skins to form a container with a void that can be filled by cellulose fibers, means to insert the cellulose fibers into the void formed by the one or more skins, and means to close the skin in a way that contains the cellulose fibers in the container. That forming machine may also include means to form a tube of skin material, means to insert cellulose material into the tube, and means to compress sections of the tube to form closed tube sections each containing the cellulose material, wherein the compressed section are joined together where compressed.

An embodiment of the invention in the form of an insulation product is a skinned insulation assembly for application in building insulation including cellulosic insulation material, a skin to contain the cellulosic insulation material; and a binder used to close the skin to retain at least a portion of the cellulosic insulation material inside the skin, wherein the insulation assembly is sized to fit in a cavity so as to be inserted into and then to insulate the cavity. A method for making the skinned insulation assembly includes the steps of metering in lengths of a material to form skins, cutting the skins to selectable width and length, forming a cellulosic insulation material retainer with the cut skin to create a cavity, metering in quantities of cellulosic insulation material into the cavity to form the skinned assembly of cellulose, and applying the formed skinned assembly of cellulose fibers to a building structure to be insulated. The cellulosic insulation material may be compressed by dense-packing into the cavity. This can also be done to make the packaging assembly product. Alternatively, the compressing may be done by blowing to compress fibers of the cellulosic insulation material into the cavity before closing the cavity. The compressing may be done by filling the cavity with the cellulosic insulation material and then ram pressing the cellulosic insulation material to a selectable finished dimensions before closing the cavity. The method may also include the step of moving air and/or heat through the cavity to adhere the cellulosic insulation material with a binder to the cellulosic insulation retainer. The method optionally includes the steps of forming a plurality of ports in either or both of a first skin and a second skin of a cellulosic insulation retainer and filling the cellulosic insulation retainer by blowing the cellulosic insulation material through the plurality of ports into the cavity. The cavity may be closed. Further, an embodiment of the invention for making the cellulose insulation assembly product includes using a forming machine having means for metering in lengths of a material to form skins, means for cutting the skins to selectable width and length, means for forming a cellulosic insulation material retainer with the cut skin to create a cavity, and means for metering in quantities of cellulosic insulation material into the cavity to form the skinned assembly of cellulose insulation material.

More specifically, the method of insulating a building structure having open wall cavities between adjacent studs with a cellulosic insulation material includes the steps of forming on site at the building structure a batt comprising the cellulosic insulation material positioned between two skins and affixing the batt to two consecutive studs to substantially fill a wall cavity between the two consecutive studs. The method may be used to make a cellulosic insulation batt with one or more machines, by metering in lengths of paper, cutting the paper to selectable width and length, forming a cellulosic insulation material retainer with the cut skin to create a cavity, metering in quantities of cellulosic insulation material into the cavity to form the cellulosic insulation batt, and applying the formed cellulosic insulation batt to a building structure to be insulated. These steps may also be used to form packaging such as the packaging described herein. In addition, the method may further include the step of compressing the cellulosic insulation material by dense-packing into the cavity. It may also include the step of compressing by using a blower to compress fibers of the cellulosic insulation material into the cavity before closing the cavity. The compressing may also be done by filling the cavity with the cellulosic insulation material and then ram pressing the cellulosic insulation material to a selectable finished dimensions before closing the cavity. The method may also include moving air and/or heat through the cavity to adhere the cellulosic insulation material with a binder to the cellulosic insulation retainer. Additional steps include forming a plurality of ports in either or both of a first skin and a second skin of a cellulosic insulation retainer and filling the cellulosic insulation retainer by blowing the cellulosic insulation material through the plurality of ports into the cavity. A lance may be used to close the cavity.

The invention includes components of skinned cellulose assemblies, skinned cellulose assemblies, machines to fabricate skinned cellulose assemblies, methods of fabricating skinned cellulose assemblies, methods of installing skinned cellulose assemblies, and systems for installation of skinned cellulose assemblies in locations of interest such as building wall cavities and in packaging applications. The invention is further described in the following detailed description.

### BRIEF DESCRIPTION OF THE DRAWING

FIG. 1 is a simplified representation of example components and machinery to make and use a skinned cellulose packaging assembly of a first embodiment of the present invention.

FIG. 2 is a simplified representation of example components machinery to make and use a skinned cellulose packaging assembly of a second embodiment of the present invention.

FIG. 3 is a simplified representation of example components and machinery to make and use a skinned cellulose insulation assembly of a third embodiment of the present invention.

FIG. 4 is a simplified representation of example components and machinery to make and use a skinned cellulose insulation assembly of a fourth embodiment of the present invention.

FIG. 5 is a simplified representation of example components and machinery to make and use the skinned cellulose insulation assembly of a fifth embodiment of the present invention with an additional exterior insulation product.

### DETAILED DESCRIPTION OF THE INVENTION

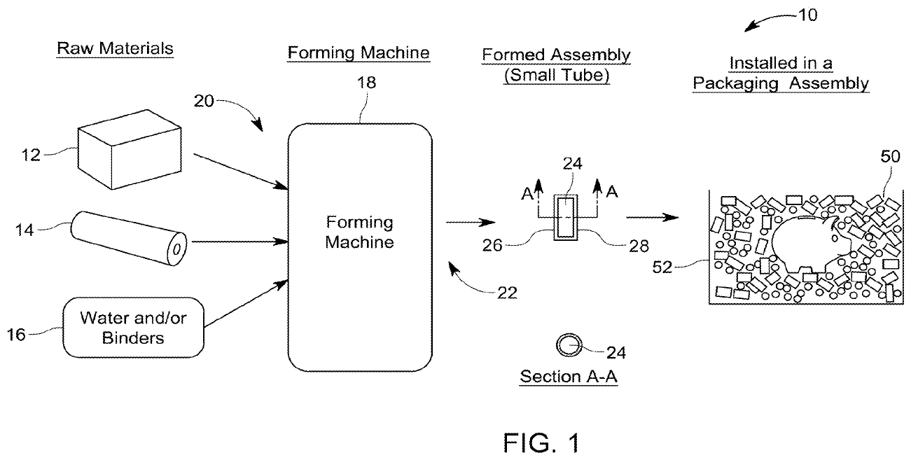

FIG. 1 shows one set of examples of materials, machinery, and steps to form a first embodiment of an insulation assembly system 10 and a first embodiment of a resultant insulation product 50 of the present invention. Other materials, specific equipment, and particular steps may be used to implement the invention for building insulation and other purposes. The insulation product 50 is formed of a plurality of materials including cellulosic insulation material 12 in fibrous form, batt covering material 14, and one or more binders 16 used to join the insulation material 12 to the batt covering material 14. The batt covering material may be paper but is not limited thereto. The materials 12-16 are inserted into forming machine 18 at input 20, which is configured to carry out a process to fabricate the insulation product 50 for transfer to a location of interest from output 22. The insulation product 50 shown in side view and section view includes processed cellulosic insulation material 24 retained between first skin 26 and second skin 28. The insulation product 50 of FIG. 1 is a packaging insulation product formed in the machine 18 to substantially seal the processed insulation material 24 in a retainer formed by the first skin 26 and the second skin 28. The insulation product 50 is shown used to protect package contents during transport, such as in a packaging box 52 as shown. Either or both of the first skin 26 and the second skin 28 may include one or more extensions for ease of transport, attachment to a substrate, or other activity of interest.

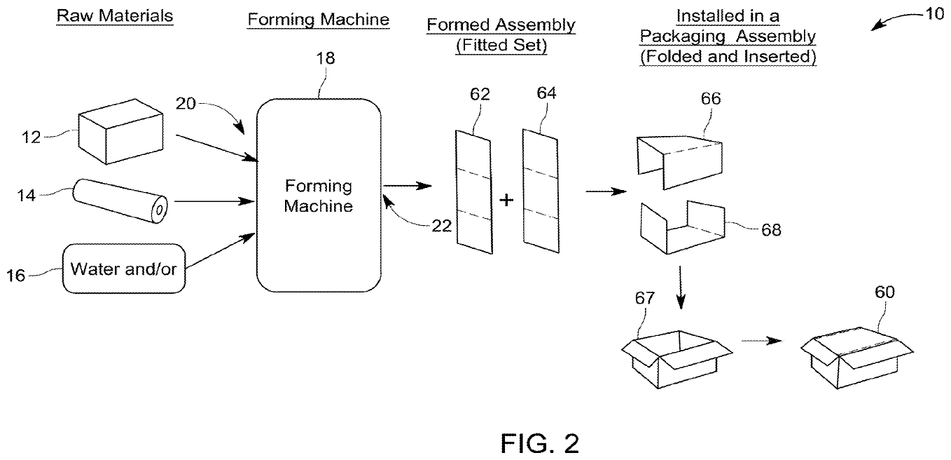

FIG. 2 shows the insulation assembly system 10 and a second embodiment of a resultant insulation product 60 of the present invention. The insulation product 60 includes a first structure 62 and a second structure 64, wherein each of the first structure 62 and the second structure 64 are fabricated using the machine 18 to generate each of the structures as a batt including a first skin and a second skin containing the cellulosic insulation material therein. The first structure 62 is formed as a foldable batt and may be folded by a user into first folded form 66. The second structure 64 is formed as a foldable batt and may be folded by a user into second folded form 68. The first folded form 66 and the second folded form 68 may then be removably or permanently inserted into a packaging box 67 to produce the insulation product 60.

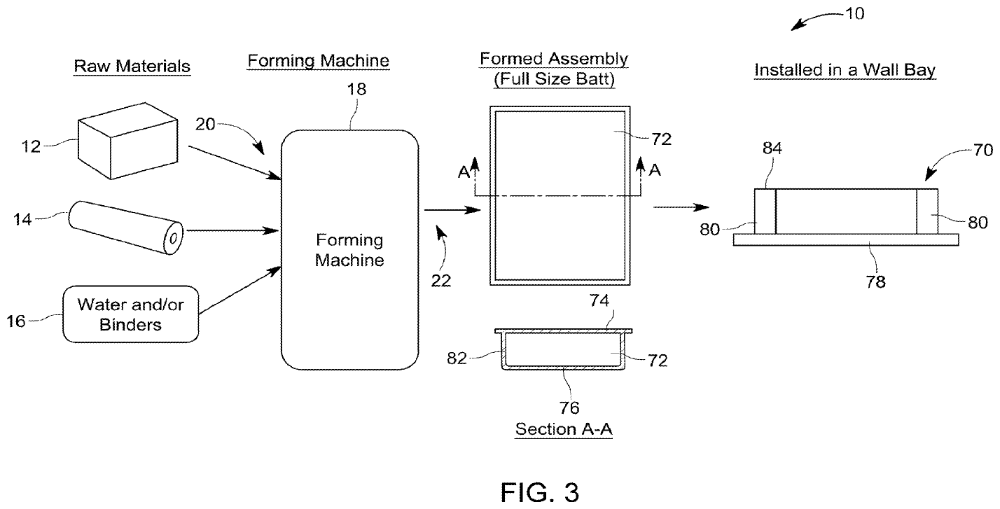

FIG. 3 shows the insulation assembly system 10 and a third embodiment of a resultant insulation product 70 of the present invention. The insulation product 70 shown in side view and section view includes processed cellulosic insulation material 72 retained between first skin 74 and second skin 76. The insulation product 70 of FIG. 3 is a building structure insulation product formed in the machine 18 to substantially insulate a cavity of a building structure between an exterior wall 78 and studs 80. The first skin 74 and the second skin 76 when joined together form sidewalls 82 that in combination define a cavity for retaining the processed cellulosic insulation material 72 therein. At least the first skin 74 includes a plurality of extensions 84 to retain the insulation product 70 to the studs 80.

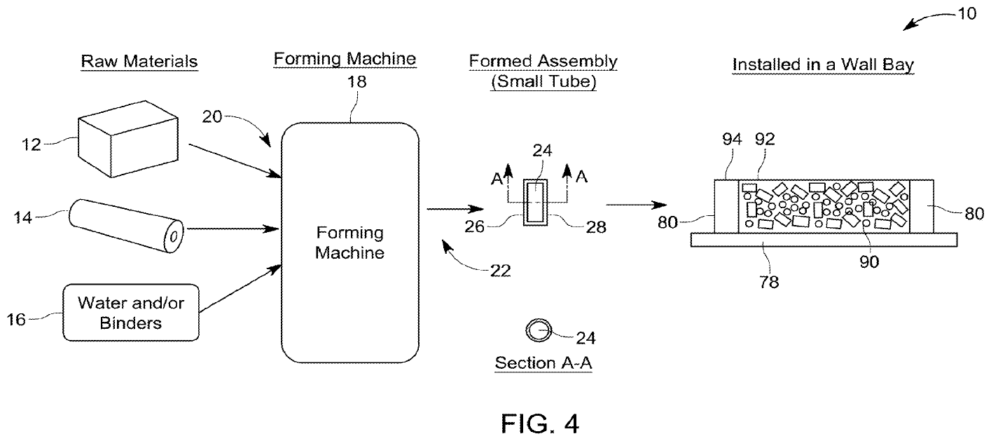

FIG. 4 shows the insulation assembly system 10 and a fourth embodiment of a resultant insulation product 90 of the present invention. The insulation product 90 shown in side view and section view includes the processed cellulosic insulation material 24 retained between the first skin 26 and the second skin 28 of the assembly of FIG. 1. The insulation product 50 of FIG. 1 is a packaging insulation product formed in the machine 18 to substantially seal the processed insulation material 24 in a retainer formed by the first skin 26 and the second skin 28. The insulation product 90 of FIG. 4 is a building structure insulation product formed in the machine 18 to form a portion of insulation of the cavity of a building structure between the exterior wall 78 and studs 80. The insulation product 90 is inserted into the cavity of the building structure and the remainder of the cavity may be filled with loose blown-in insulation fibers or other material. A containment skin 92 may be attached to the studs 80 to retain the insulation product 90 and other material therein. The containment skin 92 includes a plurality of extensions 94 to retain the insulation product 90 within the building structure cavity.

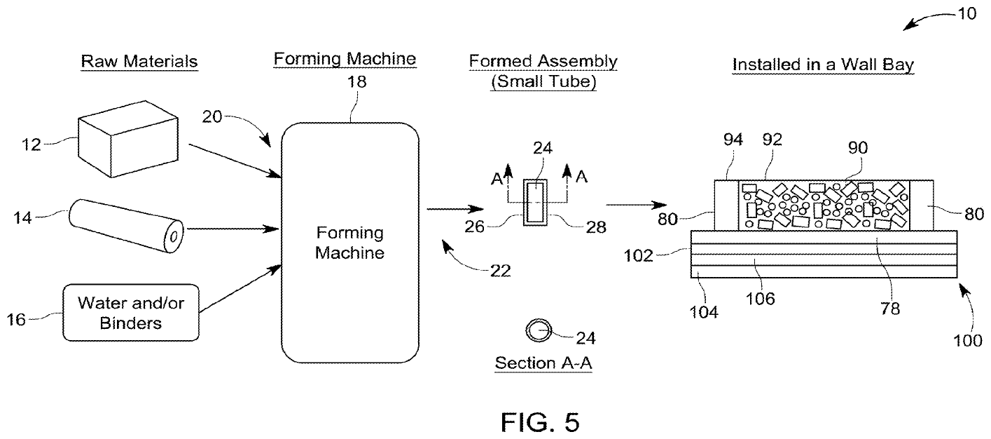

FIG. 5 shows the insulation product 90 of FIG. 4 used to insulate a building structure. The insulation arrangement of FIG. 5 includes in addition to the insulation product 90 in the cavity, an exterior insulation skin 100. The exterior insulation skin 100 includes an interior skin 102 and an exterior skin 104 that sandwich a cellulosic insulation batt or cellulose fill 106 therebetween

The skins of the products described herein may be made of one or more materials including, but not limited to, non-metallic materials such as polymeric materials, organic materials, or combinations thereof. As noted, paper may be used to form the skins. Paper based exterior skins/structures include but are not limited to Kraft paper and/or other paper-based materials, expanded paper products (described below) with paper skins, and folded paper products (described below) with paper skins. Any of these materials may contain one or more fire retardants such as borate-based fire retardants, for example. The exterior skin/structure may be on just one side of a batt, with that single face adhered to stabilized cellulose; that is, cellulose that is not loose. The paper may be perforated.

Cellulose materials that are the cellulosic insulation material include but are not limited to conventional cellulose materials fluffed by a blowing system in the field, cellulose materials separated in the field by a carding system and a blowing system, cellulose materials separated in the field with a binder added to stabilize the materials, and cellulose materials separated in the field with a binder added and then dried in the field to stabilize the materials. Any of these materials may contain one or more fire retardants, such as borate-based fire retardants, for example. The cellulose material may be loose or bound. The cellulose fibers may function as wicking of moisture from the paper skin(s).

Expansible materials may be included with cellulose; that is, the addition of expansible materials that either create internal impediments to airflow, act as binders for cellulose fibers, stabilize the overall assembly improving structural integrity, or expand the volume of the overall assembly. Examples include but are not limited to reactive chemical foaming agents included with cellulose upon insertion, which is expanded following the insertion into the assembly, and cellulose materials containing microbeads that expand when heated, increasing the bulk of the overall assembly.

Expanded or expansible products may be used as skins, including but not limited to laminated product with pre-expanded microbeads, laminated products with microbeads expanded in the field prior to installation, and laminated products with microbeads expanded in the field after installation. These microbeads may be expanded by the application of heat, which vaporizes a phase change material (such as water, alcohol, etc.) within the beads. Alternatively, a foam may be utilized as a skin, where that foam is created prior to assembly, a skin is foamed or expanded during assembly of the insulation assembly, or the skin is foamed or expanded during installation.

Folded paper products may be utilized as part of the assemblies. These folded paper products may include but are not limited to corrugations folded into paper assemblies and other folding patterns to capture air (such as, for example, the formation of balloons by folding) may be employed as at least one of the batts. These filled folded paper products may include filled folded paper products wherein folded paper products described above include cavities filled with material including but not limited to cellulose insulation material.

The insulation products of the invention may also include expansible and/or expanded folded paper products wherein folded paper products described above where some or all of the folds are subsequently expanded. The folding of the expansible paper products may be such that when the folded expansible paper products are expanded, modified geometries are formed, which may create larger cavities in the structure. Insulation assemblies that are ultimately bulky can first be shipped in a relatively flat form before being expanded onsite.

Vapor barrier(s), such as paper and other materials may be selected and included to minimize the passage of fluids such as air or liquid therethrough to the insulation material are established with the method of the invention. Optionally, the vapor barrier may be configured to enable selectable passage of fluid therethrough, such as to enable drying of the insulation material if needed. The vapor barrier may be a treatment on either or both paper skins.

Insulation products of the present invention, which may be used to insulate thermally and/or from deformative loading (such as for cushioning in a packaging assembly), for building structure insulation or packaging, for example, are described as follows.

An insulated skinned assembly made from paper and cellulose insulation that form an insulative batt that can be installed in bays between studs in wall assemblies to provide thermal insulation. In one embodiment, the assembly includes a paper face that can be stapled to the face of the stud assemblies. In another embodiment, the batt is formed by a machine that allows the width, height, and depth of the batt to be adjusted in the field in response to installer needs. The batt may include expansible paper elements. Cellulose insulation may be used as part of the skinned assembly. There may be multiple trapped cavities with insulating properties. A fill material of the batt that is stabilized via bonding can be provided so as not to move in handling, installation, or after installation. The fill material may be densely packed to a self-supporting overall material bulk density so as not to move in handling, installation, or after installation. The components of the assembly, including any cellulosic material and/or skin may be treated with a fire retardant such as a borate-based fire retardant. The fire retardant may be a liquid borate-based fire retardant, for example.

Examples of one or more machines that may be used to form the insulated assemblies are described as follows and can be readily understood by those skilled in the art of insulation product fabrication and installation.

The components that may be combined and/or modified through use of the one or more machines to output the insulative assemblies of the present invention include some or all of the following materials as have been identified herein: paper (in the form of folded paper or rolls of paper); cellulose (in the form of loose blown cellulose, compressed cellulose bales, or bulk hoppers of cellulose); expandible paper (for example, paper containing microbeads that expand when heated); binders to adhere layers of paper; binders to adhere cellulose fibers to each other forming a stabilized matrix; binders to adhere cellulose fibers to layers of paper; and water to activate binders included in cellulose matrix or on paper.

One or more of the machines of the present invention are configured to carry out several actions to transform the insulation materials described into insulation assemblies of selectable various characteristics and configurations. These actions include the receiving of the materials, the formation of a skin from the received materials, optionally forming a series of linked assemblies, optionally forming a full-bay fill assembly to make insulation batts, and optionally forming a full-cavity fill assembly to make insulated skinned packaging assemblies.

The insulation fabrication machine may do any of the following actions in receiving materials for forming laminated insulating assemblies. Metering in lengths of paper (which may include paper treated with a fire retardant and/or expansible paper products that are later expanded in processing). Cutting paper to width or to length. Metering in quantities of cellulose. Metering in quantities of cellulose to fill a cavity or partially to a known weight. Metering in quantities of cellulose to fill a cavity or partially to a specified back-pressure.

The cellulose insulation may be shipped to the site in compressed form. The machine may break the compressed cellulose down into individual fibers by doing any of the following: agitating the cellulose; blowing the cellulose through fans or hoses; carding the cellulose to separate and orient the cellulose fibers; adding a binder or water to the cellulose to promote bonding; and repeating any of the steps above.

The machine may be configured to form a skin by any one or more of the following operations: folding paper or skin materials to a designated, programmed geometry; folding paper at the start or end of an assembly (i.e., to make the joint between the front and back faces of a batt that will be assembled into the wall, which will be placed at the top or bottom of a long bay); folding paper along the length of the assembly (i.e. to make the joint between the front and back face of a laminated batt that will be assembled into a wall, where this seam will run vertically along the studs along the length of a bay); filling cavities in paper with cellulose insulation and/or filling cavities via blowing cellulosic material into a cavity of the finished product through the largest face of the finished assembly before closing that face with a final skin.

Alternatively, the machine may be configured to form small insulation assemblies, which include one or more skins and a cellulose fill. As an example, a tube may be formed by the machine and then filled with cellulose fill. The tube may be cut and crimped to contain the cellulose fill inside the tube.

The one or more machines may also be configured to: compress cellulose by dense-packing into a cavity using a blower to compress fibers into that cavity before closing the cavity; compress cellulose by filling the cavity at a lower density and then having a ram press the material to its finished dimensions before closing the cavity; and/or spray a binder into the cavity while filling.

The one or more machines may be configured to: move air and/or heat through one or more cavities before closing to adhere cellulose with a binder; fill cavities via blowing into a cavity of the finished product size through one of the smaller faces of the finished assembly before closing that face with a final skin; compress cellulose by dense-packing into a cavity using a blower to compress fibers into that cavity before closing the cavity such as by using a lance known to those skilled in the art of insulating that penetrates the cavity to the far end and then retreats partially out of the cavity as the cavity is increasingly filled; compress cellulose by filling the cavity at a lower density and then having a ram press the material to its finished dimensions before closing the cavity; spray a binder into the cavity while filling; move air and/or heat through the cavity before closing to adhere cellulose with a binder; and/or heat components or assemblies to expand expansible paper.

The one or more machines may further be configured to carry out one or more of the following functions: The expansible paper may include microbeads containing a liquid material that undergoes a phase change upon heating. When heated in the machine, the heating may occur via forced hot air, via contact with hot rollers, via microwave heating, or other means. Microwave heating may be used as the heat will go to the location of moisture in the assembly, avoiding heating other parts as quickly, and working to apply the heat as evenly as practical for even drying.

The one or more machines may be configured for rolling of seams of assemblies to put faces into contact with binders and providing heat via rollers to quickly dry binders in rolled seams. The machine can heat assemblies to dry binders in insulating layers such as cellulose layer. Optionally, the machine may flow hot air through layers of cellulose to help dry cellulose assemblies. More generally, microwaves may be used to rapidly dry binders in cellulose assemblies. The machine may be configured for rolling of filled assemblies to a specified thickness (i.e., if a rectangular cavity is filled, it may initially be “pillowed”, and the rolling may compress it back into rectangular form before the processing is completed).

The one or more machines include controls for at least: controlling position, orientation of layers and barriers, and densities of assemblies; controlling air pressure to control cellulose density; controlling ram positions to control cellulose density; and/or controlling lance positions to control cellulose density.

For packaging applications, there may be cases where multiple skins sections are to be filled successively with unfilled sections of paper between them (to permit folding into boxes). For example, to make insulating pads for a 6×6×6″ inside dimensions box, one may want three pads with dimensions of 6×6×1, 6×4×1 and 6×4×1 and a non-filled paper length of 0.5-1″ between each pad to permit folding. Then a successive set of pads of the same dimensions can be fit into the remaining three faces of the box.

The one or more machines may be used to form a cavity of the dimensions that represent the dimensions of the filled insulated assembly to be formed. The length, height, and width of the cavity can be configurable. Lining multiple sides of the cavity with paper (i.e., five sides), where the paper is automatically fed from folded or rolled paper stock and folded to the dimensions of the cavity. The machine may then blow loose-blown insulation into the cavity to fill the cavity. If one edge of the cavity is left open, the loose-blown insulation may be inserted from that edge. As insulation is blown into the cavity, air may be exhausted out of the cavity via the same edge, using some sort of a filter or a filter cloth to separate fibers from the airflow. If the insulation in the cavity is to be stabilized via a binder, a binder and/or moisture may be blown into the bay with the cellulose. Loose-blown insulation may optionally be stabilized with a binder using the one or more machines to apply heat or airflow to dry the binder before removal from the batt-forming machine. The process may involve using the machine to fold paper over one or more previously unsealed edges of the cavity when the blowing process is complete. The machine may optionally be configured to enable removal of a completed assembly from a location.

The steps and functions described above for making and positioning an insulation assembly for thermal insulation of a building may also be used to form full-cavity fill assembly to make insulated laminated packaging assemblies; that is, the assemblies described may be modify or employed substantially as is to make assemblies for cushioning or packaging, rather than for an insulating batt for a building.

Specific examples of installing assemblies such as those described above include walls insulated by cellulose-based batts formed in the field, and walls insulated with a hybrid structure comprising partially filled batts and partially blown-in materials.

For the cellulose-based batts formed in the field, the insulating batts are formed to width, depth and height and height of bay in the field by creating a sandwich of insulating material between paper-based exterior skins. Alternatively, insulating batts are formed to a portion of the width, depth and/or height of bay in the field by creating a sandwich of insulating material between paper-based exterior skins, such that the bays can be filled by a number of these batts. For a specific example, two insulated batts each sized to approximately half the width of a bay×depth of bay×height of bay and fastened via staples/screws to the bay. In a 16″ on-center bay with 2×6 studs (with studs measuring 1.5×5.5″), there is a cavity of 14.5″×5.5″ to be filled. Using two 7.25″×5.5″ batts will fill the bay. The use of two batts minimizes “pillowing” (i.e., fastening the edge of each batt at the middle of the bay to the back wall avoids the middle of the bay pillowing out excessively).

For the partial batt/partial blown-in option, two insulated batts are sized to leave a central vertical cavity for blowing. For example, in a 16″ on center bay, using two insulated batts each sized to approximately 5.5″ by 5.5″ ×height of bay, consuming most of the volume of the bay and fastened via staples/screws to the bay. In a 16″ on-center bay with 2×6 studs (with studs measuring 1.5×5.5″), there is a cavity of 14.5″×5.5″ to be filled. Using two 5.5″×5.5″ batts will fill 11″ of the 14.5″ opening, leaving an opening of 3.5″×5.5″, which can be covered in a way that allows blown insulation to be inserted between the two batts. The fastening of the two 5.5″ batts to the back wall of the bay avoids “pillowing” when the blown material is inserted, and the blown material can fill not only the central part of the bay, but also may be able to fill other cracks/cavities in the entire bay assembly.

While the present invention has been described with reference to specific examples, it is not intended to be so limited. Instead, the present invention is defined by the following claims and reasonable equivalents.

What is claimed is:

1. A padded skinned assembly for application in packaging applications comprising:
a cellulosic insulation material;
a skin to contain the cellulosic insulation material; and
a binder to close the skin to retain at least a portion of the cellulosic insulation material inside the skin,
wherein the skinned assembly is sized to fit a particular geometry cavity so as to be inserted into that cavity and to fit snugly and to provide insulation and/or padding therein.

2. A padded skinned assembly for application in packaging applications comprising:
a cellulosic insulation material;
a skin to contain the cellulosic insulation material; and
a binder to close the skin to retain at least a portion of the cellulosic insulation material inside the skin,
wherein multiple padded skinned assemblies are utilized inside a container for the purpose of providing cushioning or insulation to the contents of a package in the container.

3. The padded skinned assembly as claimed in claim 2, wherein the skin is formed into a tubular shape.

4. The padded skinned assembly as claimed in claim 3, wherein the tubular shape is formed into a plurality of tubular sections, wherein each tubular section includes the cellulosic insulation material, wherein adjacent ones of the tubular sections are connected to one another but isolated so that the cellulosic insulation material does not move from one tubular section to another, and wherein a first portion of the tubular sections may be separated from a second portion of the tubular sections.

5. A method of filling voids in a package with a skinned cellulosic assembly, the method comprising the steps of:
forming a skinned cellulose assembly with a cellulosic insulation material and a skin to contain the cellulosic insulation material; and
filling a void in a package with the skinned cellulose assembly,
wherein the skinned cellulose assemblies are designed to fit snugly in the package.

6. A method of filling voids in a package with a plurality of skinned cellulosic assemblies, the method comprising the steps of:
forming a plurality of skinned cellulose assemblies, wherein each of the skinned cellulose assemblies includes a cellulosic insulation material contained in a skin;
and
filling a void in a package with the plurality skinned cellulose assemblies,
wherein the number of skinned cellulose assemblies selected for insertion in the package is such as to predominantly fill the void in the package.

7. A forming machine for assembling a skinned cellulose assembly, the forming machine comprising:
means to form one or more skins from a skin material of controlled dimensions;
means to assemble the one or more skins to form a container with a void that can be filled by cellulose fibers;
means to insert the cellulose fibers into the void formed by the one or more skins; and
means to close the skin in a way that contains the cellulose fibers in the container.

8. The forming machine as claimed in claim 7 further comprising:
means to form a tube of skin material;
means to insert cellulose material into the tube; and
means to compress sections of the tube to form closed tube sections each containing the cellulose material, wherein the compressed section are joined together where compressed.

9. A skinned insulation assembly for application in building insulation comprising:
a cellulosic insulation body;
a skin to contain the cellulosic insulation body; and
a binder used to close the skin to retain at least a portion of the cellulosic insulation body inside the skin,
wherein the insulation assembly is sized to fit in a cavity so as to be inserted into and then to insulate the cavity.

10. A method of making a skinned assembly of cellulose fibers for building insulation with one or more machines, the method comprising the steps of:
metering in lengths of a material to form skins;
cutting the skins to selectable width and length;
forming a cellulosic insulation material retainer with the cut skin to create a cavity;
metering in quantities of cellulosic insulation material into the cavity to form the skinned assembly of cellulose; and
applying the formed skinned assembly of cellulose fibers to a building structure to be insulated.

11. The method as claimed in claim 10, further comprising the step of compressing the cellulosic insulation material by dense-packing into the cavity.

12. The method as claimed in claim 11, wherein the step of compressing involves using a blower to compress fibers of the cellulosic insulation material into the cavity before closing the cavity.

13. The method as claimed in claim 11, wherein the step of compressing involves filling the cavity with the cellulosic insulation material and then ram pressing the cellulosic insulation material to a selectable finished dimensions before closing the cavity.

14. The method as claimed in claim 10, further comprising the step of moving air and/or heat through the cavity to adhere the cellulosic insulation material with a binder to the cellulosic insulation retainer.

15. The method as claimed in claim 10, further comprising the steps of:
forming a plurality of ports in either or both of a first skin and a second skin of a cellulosic insulation retainer; and
filling the cellulosic insulation retainer by blowing the cellulosic insulation material through the plurality of ports into the cavity.

16. The method as claimed in claim 10, further comprising the step of compressing the cellulosic insulation material into the cavity by dense-packing using a blower to compress fibers of the cellulosic insulation material.

17. The method as claimed in claim 10, further comprising the step of closing the cavity such as by using a lance.

18. A forming machine for making a skinned assembly of cellulose insulation material for building insulation, the forming machine comprising:
means for metering in lengths of a material to form skins;
means for cutting the skins to selectable width and length;
means for forming a cellulosic insulation material retainer with the cut skin to create a cavity; and
means for metering in quantities of cellulosic insulation material into the cavity to form the skinned assembly of cellulose insulation material.

19. A skinned insulation assembly for application as insulation on building exteriors comprising:
a cellulosic insulation batt;
a skin adhered to the cellulosic insulation batt; and
a binder used to attach the skin to at least a portion of the cellulosic insulation batt,
wherein the insulation assembly is sized to fit on the exterior surface of a building object.

20. The skinned insulation assembly of claim 19 where one or more skins may be of rigid materials such as ceramic-based materials that have insulative properties.

21. A method of making a skinned assembly for application as insulation on building exteriors comprising the steps of:
forming a cellulosic insulation batt;
forming a skin adhered to the cellulosic insulation batt; and
applying a binder to attach the skin to at least a portion of the cellulosic insulation batt,
wherein the insulation assembly is sized to fit on the exterior surface of an object; and
applying the formed skinned assembly of cellulose batting to a building exterior structure to be insulated.
